(19) United States
(12) Patent Application Publication
(10) Pub. No.: US 2017/0219854 A1
(43) Pub. Date: Aug. 3, 2017

(54) Integrated Optical Modulator

(71) Applicant: Sensor Electronic Technology, Inc., Columbia, SC (US)

(72) Inventors: Grigory Simin, Columbia, SC (US); Michael Shur, Latham, NY (US)

(73) Assignee: Sensor Electronic Technology, Inc., Columbia, SC (US)

(21) Appl. No.: 15/420,429

(22) Filed: Jan. 31, 2017

Related U.S. Application Data
(60) Provisional application No. 62/289,449, filed on Feb. 1, 2016.

(51) Int. Cl. G02F 1/035; G02F 1/03

(52) U.S. Cl. CPC G02F 1/035; G02F 1/0316; G02F 2202/20

(57) ABSTRACT

An optical modulator is provided. The optical modulator can include a wave guide layer made of an electro-optical material with two or more electrodes directly contacting the wave guide layer. Each electrode can include an associated optical wave guide region, which is located within the wave guide layer. Each optical wave guide region is aligned with a lateral location corresponding to an electric field peak, which can be generated during operation of the optical modulator in a circuit, associated with the corresponding electrode. One or more voltage sources in a circuit can be operated to generate an electric field peak at one or more of the electrodes.

### REFERENCE TO RELATED APPLICATIONS

The current application claims the benefit of U.S. Provisional Application No. 62/289,449, filed on 1 Feb. 2016, which is hereby incorporated by reference.

### TECHNICAL FIELD

The disclosure relates generally to optical modulation, and more particularly, to an optical modulator, which can operate using a significantly lower control voltage.

### BACKGROUND ART

Significant interest has been focused on solid-state light sources (SSLSs), such as light emitting diodes and lasers, and particularly those that emit light in the blue and deep ultraviolet wavelengths. These devices may be capable of being incorporated into various applications, including communications, solid-state lighting, biochemical detection, high-density data storage, and the like. Many SSLS applications require modulating the emitted optical power. Two major types of optical modulators are utilized, current modulators and external modulators.

Optical power modulation can be achieved by modulating the SSLS pumping currents using electronic circuits connected to SSLS. For example, FIG. 1 shows an illustrative circuit diagram of a control circuit for SSLS modulation according to prior art. The circuits are fabricated separately from the SSLSs and are connected using wiring or similar techniques. These solutions may adversely affect the performance of the SSLS by generating parasitic circuit parameters, which increase switching time and lead to unwanted transients. In addition, hybrid type connections adversely affect the system reliability and temperature stability.

External optical modulators modulate the amplitude or phase of the emitted light, whereas the SSLS operates in continuous (CW) mode. Known solutions of external optical modulators use an electronic circuit connected to electrodes formed over nonlinear optical media, thereby changing the refractive index or other parameters of the optical guiding systems. These solutions also involve parasitic parameters adversely affecting the modulation speed and system reliability.

For example, FIGS. 2A and 2B show conventional external optical modulators according to the prior art. In each case, modulation is achieved using a dependence of refractive index on the applied electric field. An optical waveguide is formed in a material having a strong electro-optical effect, i.e., a strong refractive index-electric field dependence. Lithium niobate (LiNbO₃) is a commonly utilized material.

A change in the refractive index n at the voltage V applied between electrodes separated by the distance dₑ, is given by:

$$Δ n = - 0.5 {n}^{3} {r}_{33} \frac{V}{{d}_{e}} ,$$

where r₃₃ is the electro-optic coefficient of the material between the electrodes (e.g., LiNbO₃). An additional phase shift due to refractive index modulation is given by:

Δφ(2π/λ)ΔnL,

where λ is the wavelength in the waveguide and L is the length of the index modulation region along the waveguide. The deepest modulation is achieved when λφ=π, or

$$Δ {n}_{π} = \frac{λ}{2 L} .$$

From this, the absolute value of the voltage required to achieve π-shift can be calculated as:

$${V}_{π} = \frac{Δ {n}_{π} {d}_{e}}{0.5 {n}^{3} {r}_{33}} = ( \frac{λ}{L} ) ( \frac{{d}_{e}}{{n}^{3} {r}_{33}} ) .$$

For LiNbO₃, n≈2.2 and r₃₃≈30.9 pm/V. A simple estimate shows that at an optical wavelength λ=0.25 μm (ultraviolet light), a distance between the electrodes dₑ=3 μm, and an electrode length L=10 μm, the required voltage V_{π}≈228 Volts. A high modulation voltage makes achieving high modulation speed extremely difficult. The required modulation voltage can be reduced by lengthening the modulator electrodes. For an electrode length L=50 μm, the required voltage V_{π}≈46 V, which is more manageable. However, longer electrodes increase the capacitance of the modulator and in turn reduce the maximum modulation speed.

### SUMMARY OF THE INVENTION

Aspects of the invention provide an optical modulator. The optical modulator can include a wave guide layer made of an electro-optical material with two or more electrodes directly contacting the wave guide layer. Each electrode can include an associated optical wave guide region, which is located within the wave guide layer. Each optical wave guide region is aligned with a lateral location corresponding to an electric field peak, which can be generated during operation of the optical modulator in a circuit, associated with the corresponding electrode. One or more voltage sources in a circuit can be operated to generate an electric field peak at one or more of the electrodes.

A first aspect of the invention provides an optical modulator comprising: a wave guide layer formed of an electro-optical material; a first electrode directly contacting a first side of the wave guide layer; a second electrode directly contacting the first side of the wave guide layer, wherein the first and second electrodes are located laterally adjacent to each other; a first optical wave guide region, wherein the first optical wave guide region is located within the wave guide layer and is aligned with a first lateral location corresponding to a first electric field peak associated with the first electrode; and a second optical wave guide region, wherein the second optical wave guide region is located within the wave guide layer and is aligned with a second lateral location corresponding to a second electric field peak associated with the second electrode.

A second aspect of the invention provides a circuit comprising: an optical modulator comprising: a wave guide layer formed of an electro-optical material; a first electrode directly contacting a first side of the wave guide layer; a second electrode directly contacting the first side of the wave guide layer, wherein the first and second electrodes are located laterally adjacent to each other; a first optical wave guide region, wherein the first optical wave guide region is located within the wave guide layer and is aligned with a first lateral location corresponding to a first electric field peak associated with the first electrode; and a second optical wave guide region, wherein the second optical wave guide region is located within the wave guide layer and is aligned with a second lateral location corresponding to a second electric field peak associated with the second electrode; and a set of control voltage sources, wherein the set of control voltage sources are configured to operate the optical modulator to selectively create one of: the first electric field peak or the second electric field peak.

A third aspect of the invention provides an optical modulator comprising: a wave guide layer formed of an electro-optical material; a source electrode located on a first side of the wave guide layer; a first gate electrode located on the first side of the wave guide layer; a second gate electrode located on the first side of the wave guide layer; a drain electrode located on the first side of the wave guide layer, wherein the first and second gate electrodes are located laterally between the source electrode and the drain electrode; a first optical wave guide region located within the wave guide layer, wherein the first optical wave guide region is aligned with an edge of the first gate electrode closest to the drain electrode; and a second optical wave guide region located within the wave guide layer, wherein the second optical wave guide region is aligned with an edge of the second gate electrode closest to the drain electrode.

The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative circuit diagram of a control circuit for SSLS modulation according to prior art.

FIGS. 2A and 2B show conventional external optical modulators according to the prior art.

FIGS. 3A-3C show illustrative two electrode optical modulators according to embodiments.

FIGS. 4A and 4B show an illustrative circuit and electric field profiles during operation of an optical modulator according to an embodiment.

FIGS. 5A and 5B show an illustrative field-effect transistor optical modulator and electric fields corresponding to two different applied voltages according to embodiments.

FIGS. 6A and 6B show illustrative field-effect transistor optical modulators with wave guide regions formed within the semiconductor layers forming the field-effect transistor according to embodiments.

FIG. 7 shows an illustrative optical modulator including a semiconductor heterostructure according to an embodiment.

FIG. 8 shows another illustrative optical modulator including a semiconductor heterostructure according to an embodiment.

FIG. 9 shows an illustrative flow diagram for fabricating a circuit according to an embodiment.

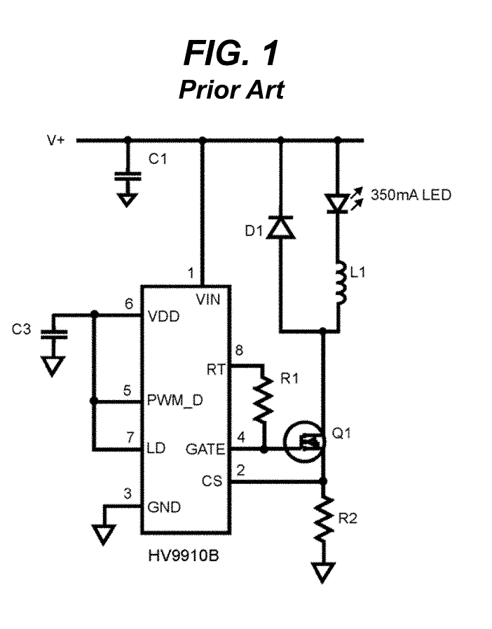

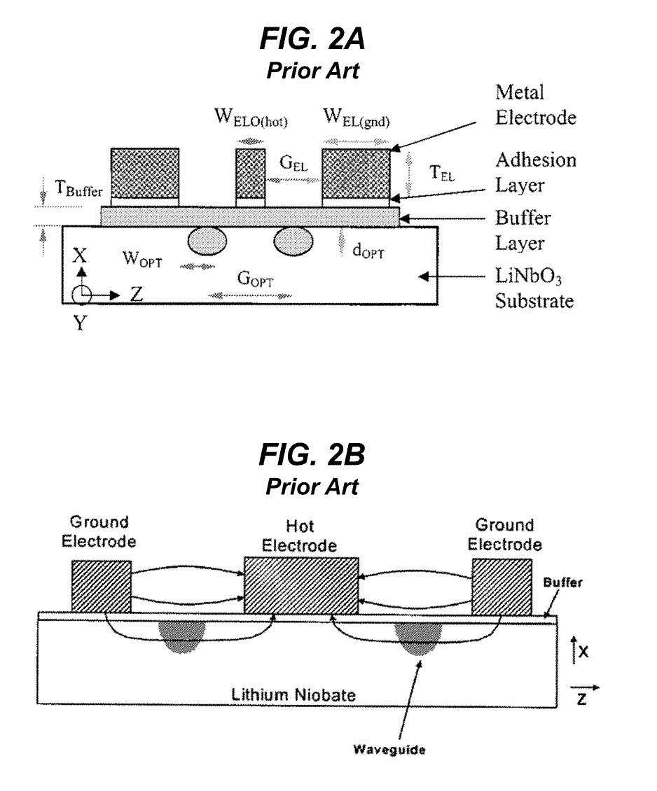

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide an optical modulator. The optical modulator can include a wave guide layer made of an electro-optical material with two or more electrodes directly contacting the wave guide layer. Each electrode can include an associated optical wave guide region, which is located within the wave guide layer. Each optical wave guide region is aligned with a lateral location corresponding to an electric field peak, which can be generated during operation of the optical modulator in a circuit, associated with the corresponding electrode. One or more voltage sources in a circuit can be operated to generate an electric field peak at one or more of the electrodes.

As used herein, unless otherwise noted, the term “set” means one or more (i.e., at least one) and the phrase “any solution” means any now known or later developed solution. It is understood that, unless otherwise specified, each value is approximate and each range of values included herein is inclusive of the end values defining the range. As used herein, a “characteristic size” of an object corresponds to a measurement of the physical size of the object that defines its influence on a system. As also used herein, an “electro-optical material,” also referred to as a piezo-electric material, is any material having a strong electro-optical effect, i.e., a strong refractive index-electric field dependence. In an embodiment, electro-optical materials are materials having a r₃₃ electro-optic coefficient greater than five. In a more particular embodiment, electro-optical materials are materials having a r₃₃ electro-optic coefficient greater than ten.

An embodiment of an optical modulator described herein can be monolithically integrated with the electronic device affecting the wave guide refractive index. In this case, fast modulation with low parasitic parameters can be achieved. A strong electric field non-uniformity can be generated at an edge of an electrode, and utilized to increase the modulation efficiency. As a characteristic size of the electric field non-uniformity is typically in a micron-submicron range, embodiments of the optical modulator can be particularly useful for modulating short wavelength light sources, such as ultraviolet solid state light sources. Such a solid state light source can comprise one or more light emitting diodes. However, it is understood that this is only illustrative, and other light sources, such as a laser, can be modulated using an optical modulator described herein.

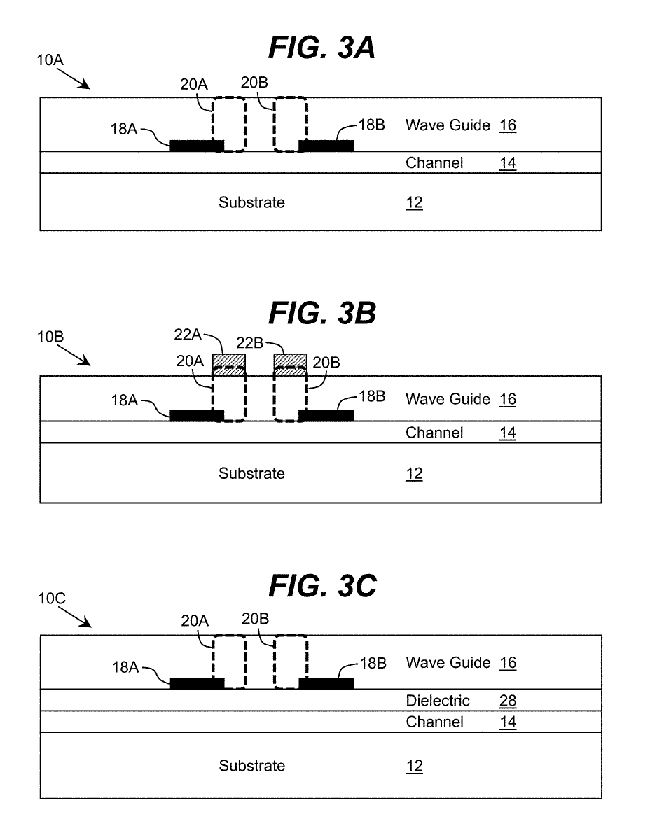

Turning to the drawings, FIGS. 3A-3C show illustrative optical modulators 10A-10C, respectively, according to embodiments. Each optical modulator 10A-10C includes a substrate 12, a channel 14, and a wave guide layer 16. The substrate 12 can comprise any dielectric or semiconductor material suitable for use in fabricating the channel 14 and electrodes 18A, 18B thereon. Illustrative substrate materials include silicon, gallium arsenide (GaAs), gallium nitride (GaN), sapphire, and/or the like. The channel 14 also can comprise a suitable dielectric or semiconductor material. In a more particular embodiment, the channel 14 is formed of a semiconductor material to provide stronger electric field peaks during operation of the optical modulator 10A as described herein. Illustrative semiconductor materials for the channel 14 include GaAs, GaN, silicon carbide (SiC), and/or the like.

The wave guide layer 16 can be formed of an electro-optical material, which exhibits strong electro-optical effects and has high piezo-electric coefficients. Examples of such materials include GaN, AlGaN, InGaN, lithium tantalate (LiTaO3), strontium titanate (SrTiO₃), barium titanate (BaTiO₃), lithium niobate (LiNbO₃), and/or the like. The optical modulators described herein have an integrated design, in which the electrodes and wave guides are monolithically integrated. To this extent, each optical modulator 10A-10C includes a pair of electrodes 18A, 18B, formed within the heterostructure of the optical modulator 10A-10C. For example, the electrodes 18A, 18B are shown formed directly on the channel 14 of the optical modulator 10A. Each electrode 18A, 18B can be formed of any suitable material, such as a nickel, gold, platinum, chromium, titanium, alloys or stacks of these metals, and other similar metals and metal combinations.

Each optical modulator 10A-10C includes an optical wave guide region 20A, 20B for each electrode 18A, 18B. A location and the dimension of each optical wave guide region 20A, 20B can be selected based on a location of a peak electrical field generated during operation of the optical modulator 10A-10C. In an embodiment, each optical wave guide region 20A, 20B is configured such that the peak electrical field region overlaps fully or partially with a cross-section of the optical wave guide region 20A, 20B. For example, each of the optical wave guide regions 20A, 20B can be formed at an interior edge of each electrode 18A, 18B.

The optical wave guide regions 20A, 20B can be formed using any solution. For example, each optical wave guide region 20A, 20B can be formed by diffusing titanium (Ti) into the wave guide layer 16, which is formed of an electro-optical material (e.g., LiNbO₃, or alike materials). However, it is understood that any other solution for forming a wave guide region can be utilized. For example, a wave guide region 20A, 20B can be formed using a semiconductor heterostructure, such as an AlN/AlGaN heterostructure, a GaN/AlGaN heterostructure, and/or the like.

In FIG. 3B, the optical modulator 10B includes a pair of ridge optical wave guides 22A, 22B. As illustrated, each ridge optical wave guide 22A, 22B can be formed on a surface of the wave guide layer 16 at a location directly above a corresponding a region of significant non-uniformities within an electric field present between the electrodes 18A, 18B, thereby forming a wave guide region 20A, 20B therein. The layout of the ridge optical wave guides 22A, 22B can be created using surface profiling, e.g., by etching or any other technique. In an embodiment, each ridge optical wave guide 22A, 22B is formed of the same material as the wave guide layer 16. In this case, the wave guide layer 16 can be fabricated (e.g., grown) to a thickness including the ridge optical wave guides 22A, 22B, and subsequently etched to form the ridge optical wave guides 22A, 22B. While the ridge optical wave guides 22A, 22B are shown formed on an exterior surface of the wave guide layer 16, it is understood that the profiling can be performed on another surface, such as an exterior surface of the substrate 12, to create variation in the refraction index. The optical modulator 10B can be configured and operated in a circuit in the same manner as shown in FIG. 3B in conjunction with the optical modulator 10A.

It is understood that embodiments of an optical modulator described herein can include one or more additional features and/or alternative configurations. To this extent, in embodiments of the optical modulators described herein, the electrodes 18A, 18B can form a metal-semiconductor-metal (MSM) structure, a metal-semiconductor-insulator-metal (MSIM) structure, a field effect transistor, and/or the like. In the optical modulators 10A, 10B, the electrodes 18A, 18B are located directly on the channel 14, thereby forming an MSM structure (e.g., when the channel 14 is formed of a semiconductor). As illustrated in the optical modulator 10C, a dielectric layer 28 can be located between the channel 14 and the electrodes 18A, 18B, thereby forming the MSIM structure. The dielectric layer 28 can be formed of any suitable dielectric material, such as silicon dioxide (SiO₂), silicon nitride (Si₃N₄), aluminum oxide (Al₂O₃), and/or the like.

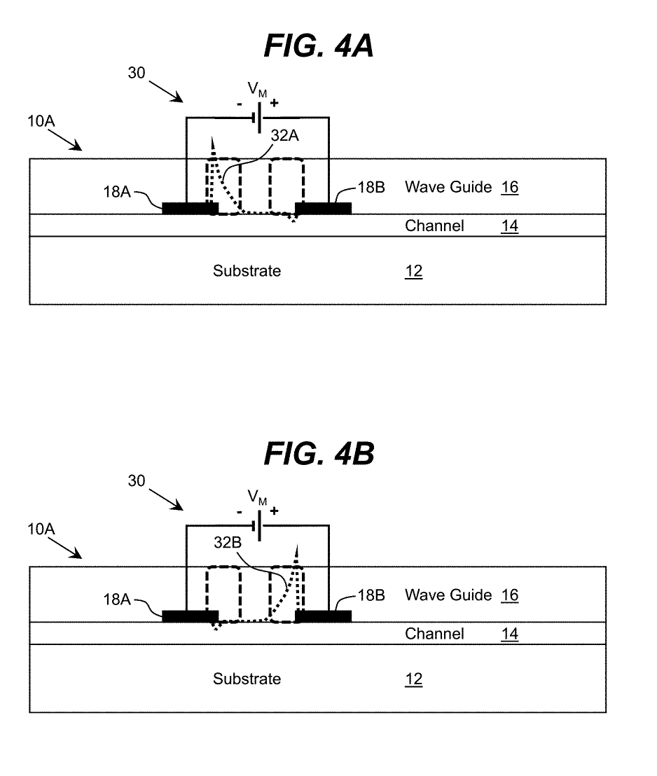

A circuit including an optical modulator 10A-10C can be configured to create strong non-uniformities in the electric field at the edges of the metal electrodes corresponding to the optical wave guides to achieve a lower control voltage. For example, FIGS. 4A and 4B show an illustrative circuit 30 and electric field profiles 32A, 32B during operation of an optical modulator 10A according to an embodiment. As illustrated in FIG. 3A, a circuit 30 can provide a modulation voltage V_{M} (also referred to as a control voltage) to the electrodes 18A, 18B of the optical modulator 10A. When the modulation voltage V_{M} is negative for electrode 18A and positive for electrode 18B, the wave guide region 20A is located in a region of significant non-uniformity within the electric field 32A present between the electrodes 18A, 18B. As illustrated in FIG. 4B, when the modulation voltage V_{M} is reversed, the electric field 32B is laterally reversed, and the wave guide region 20B is located in a region of significant non-uniformity of the electric field 32B.

As a result, each wave guide region 20A, 20B is affected by a strong electric field arising from the edge non-uniformity of the corresponding electrode 18A, 18B. A typical size of the electric field peak at an electrode edge is in the range of 0.3-1 μm. Substituting the value of dₑ in the above expression with dₑ=0.5 μm, V_{π}≈38 V for L=10 μm and V_{π}≈7.6 V for L=50 μm. Therefore, the optical modulator 10A provides more than a 5-fold reduction in the required control voltage for light modulation than the prior art. While not separately illustrated, it is understood that the optical modulators 10B, 10C can be configured in a similar circuit 30 and operated similarly to provide a significant reduction in the required control voltage over the prior art.

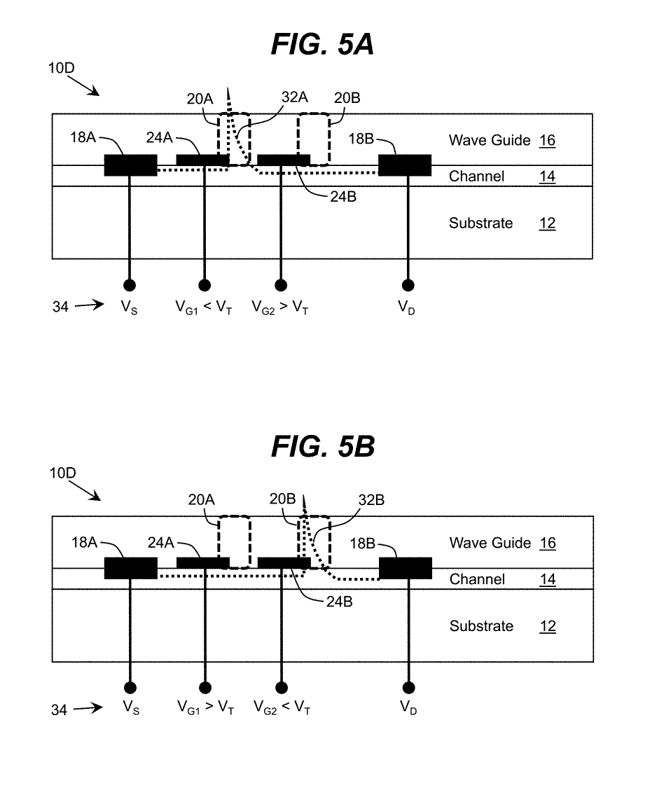

An optical modulator described herein can include various alternative configurations. For example, an optical modulator can comprise a field-effect transistor optical modulator. To this extent, FIGS. 5A and 5B show an illustrative field-effect transistor optical modulator 10D and electric fields 32A, 32B corresponding to two different applied voltages according to embodiments. In this case, the optical modulator 10D includes dual gate field-effect transistor comprising a source electrode 18A, a drain electrode 18B, and a pair of gate electrodes 24A, 24B. An optical wave guide 22A, 22B can be formed within the wave guide layer 16 on a drain-side of each gate electrode 24A, 24B, aligned with the gate edges using any solution (e.g., diffusion, surface profiling, and/or the like).

During operation of the optical modulator 10D, a circuit 34 can provide a drain voltage, V_{D}, which does not need to be modulated. As a result, the drain voltage V_{D} can be a high DC voltage (e.g., 10-100 Volts). The circuit 34 can apply a control voltage to one of the two gates 24A, 24B to fully turn off the transistor channel 14 located under the corresponding gate 24A, 24B. Under this gate bias, most of the drain voltage drop occurs across the gate edge region of the corresponding gate. The gate voltage must be below a transistor threshold voltage V_{T} to turn the channel off. FIG. 5A shows an electric field 32A present when the circuit 34 applies a gate voltage V_{G1} that is below the threshold voltage V_{T} and a gate voltage V_{G2} that exceeds the threshold voltage V_{T}. FIG. 5B shows an electric field 32B present when the circuit 34 applies a gate voltage V_{G1} that exceeds the threshold voltage V_{T} and a gate voltage V_{G2} that is below the threshold voltage V_{T}. A threshold voltage V_{T} for the optical modulator 10D can be as low as 3-5 Volts. Therefore, an even lower control voltage can be utilized for light modulation. In this example, the source electrode 18A can have a source voltage, V_{S}, which is zero potential (grounded). However, it is understood that the absolute electrode voltages in various circuit modifications can be different as long as they provide the described functionality.

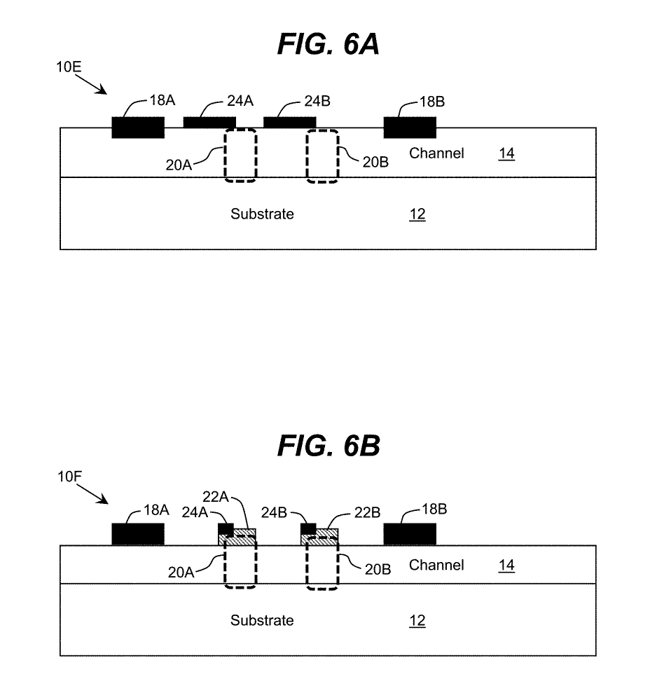

Various alternative configurations of field-effect transistor optical modulators are possible. For example, FIGS. 6A and 6B show illustrative field-effect transistor optical modulators 10E, 10F in which the wave guide regions 20A, 20B are formed within the semiconductor layers forming the field-effect transistor (e.g., the channel 14) according to embodiments. In this case, each field-effect transistor optical modulator 10E, 10F is implemented using the channel 14 as the wave guide layer. To this extent, similar to the wave guide layer 16 (FIG. 3A), the channel 14 can be formed of any type of semiconductor material that exhibits an electro-optical effect. Illustrative materials include gallium arsenide (GaAs) and gallium nitride (GaN), each of which exhibits a rather strong electro-optical effect. For example, the electro-optic coefficients for GaN are approximately five times lower than those for LiNbO₃.

The wave guide regions 20A, 20B can be formed using any solution. For example, in FIG. 6A, the wave guide regions 20A, 20B can be formed in the channel 14 using, for example, a non-uniform doping. In this case, the non-uniform doping can produce sufficient refractive index change in the wave guide regions 20A, 20B due to light absorption by free carriers. For example, silicon-doped regions can be formed in GaAs or GaN materials with a silicon dopant concentration ranging from 10¹⁶ to 10¹⁸ cm⁻³. Alternatively, in FIG. 6B, the wave guide regions 20A, 20B are formed by a pair of ridge optical wave guides 22A, 22B as described herein. As illustrated, the corresponding gates 24A, 24B can be formed on a source side of each ridge optical wave guide 22A, 22B. As a result, the optical wave guides 22A, 22B will be located in a region of the channel 14 that experiences a high electric field when the optical modulator 10F is operated as shown in conjunction with the circuit 34 (FIGS. 5A and 5B). It is understood that other solutions for forming the wave guide regions 20A, 20B can be utilized. Other illustrative solutions include impurity diffusion (e.g., silicon), ion implantation (e.g., boron, nitrogen, oxygen, etc.), and/or the like.

Embodiments of an optical modulator described herein can include a semiconductor heterostructure. For example, the heterostructure can include layers formed of group III-V materials, in which some or all of the various layers are formed of elements selected from the group III-V materials system. In a still more particular illustrative embodiment, the various layers of the heterostructure are formed of group III nitride based materials. Group III nitride materials comprise one or more group III elements (e.g., boron (B), aluminum (Al), gallium (Ga), and indium (In)) and nitrogen (N), such that B_{W}Al_{X}Ga_{Y}In_{Z}N, where 0≦W, X, Y, Z≦1, and W+X+Y+Z=1. Illustrative group III nitride materials include binary, ternary and quaternary alloys such as, AlN, GaN, InN, BN, AlGaN, AlInN, AlBN, AlGaInN, AlGaBN, AlInBN, and AlGaInBN with any molar fraction of group III elements. However, it is understood that other types of semiconductor materials, in particular other types of group III-V materials can be utilized. For example, an illustrative embodiment of an optical modulator can be formed using a heterostructure of group III arsenide based materials. Additionally, an illustrative embodiment of an optical modulator can be formed using a heterostructure of group II-VI based materials, such as zinc oxide (ZnO), cadmium oxide (CdO), magnesium oxide (MgO), and the like.

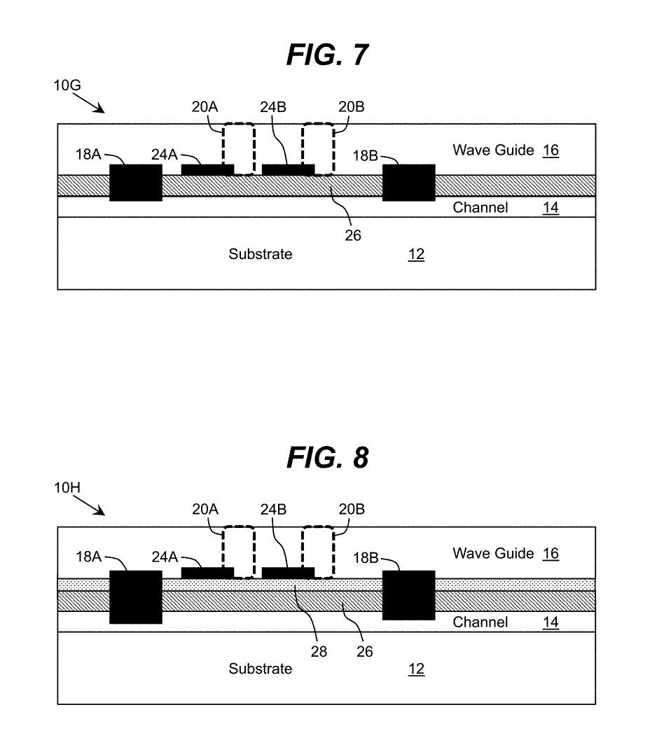

Regardless, FIG. 7 shows an illustrative optical modulator 10G including a semiconductor heterostructure according to an embodiment. In this case, the optical modulator 10G includes a channel 14 and barrier 26, each of which can be formed of a distinct semiconductor material. In an illustrative embodiment, the channel 14 is formed of gallium nitride (GaN), while the barrier 26 is formed of aluminum gallium nitride (AlGaN). FIG. 8 shows another illustrative optical modulator 10H including a semiconductor heterostructure according to an embodiment. The optical modulator 10H is configured similar to the optical modulator 10G, but also includes a dielectric layer 28. As illustrated, the dielectric layer 28 can extend between the gate electrodes 24A, 24B and the channel 14, thereby providing an insulated gate design. The dielectric layer 28 can be formed of any suitable dielectric material, such as silicon dioxide (SiO₂), silicon nitride (Si₃N₄), aluminum oxide (Al₂O₃), and/or the like.

The wave guide regions 20A, 20B for each of the optical modulators 10G, 10H can be formed using any solution (e.g., diffusion, implantation, doping, and/or the like). While not shown, it is understood that the wave guide regions 20A, 20B could be formed using ridge optical wave guides 22A, 22B as shown, for example, in FIG. 6B. In this case, the ridge optical wave guides can be formed on the wave guide layer 16. Alternatively, the ridge optical wave guides can be formed on the barrier 26 (FIG. 7) or the dielectric layer 28 (FIG. 8). In this case, as in FIG. 6B, the gates 24A, 24B can be formed on a source side of each ridge optical wave guide. Furthermore, the wave guide regions 20A, 20B can be formed within one or both of the semiconductor layers 26, 28, e.g., using a non-uniform doping. In an embodiment, a gate can be formed adjacent to a corresponding ridge optical wave guide, contacting the underlying semiconductor or dielectric layer.

While the various field-effect transistor optical modulators have been shown and described in conjunction with two gate electrodes, it is understood that embodiments of a field-effect transistor optical modulator can be implemented with more than two gate electrodes. Such an arrangement can be used, for example, to control multiple optical beams within the same integrated optical modulator. A circuit can operate such an optical modulator by biasing one gate electrode off at a time or several gate electrodes off at a time depending, for example, on the desired optical beam delays. Furthermore, while particular configurations of field-effect transistors have been shown, it is understood that a field-effect transistor optical modulator can include any of various types of field-effect transistors with a normally-on channel that is in a conducting state when no external voltage is applied to it or a normally-off channel that is in a non-conducting state when no external voltage is applied to it. Illustrative types of field-effect transistors include a high electron mobility transistor (HEMT), a junction gate field-effect transistor (JFET), a metal oxide semiconductor field-effect transistor (MOSFET), and/or the like.

While illustrative aspects of the invention have been shown and described herein primarily in conjunction with an optical modulator and a method of fabricating such a device, it is understood that aspects of the invention further provide various alternative embodiments.

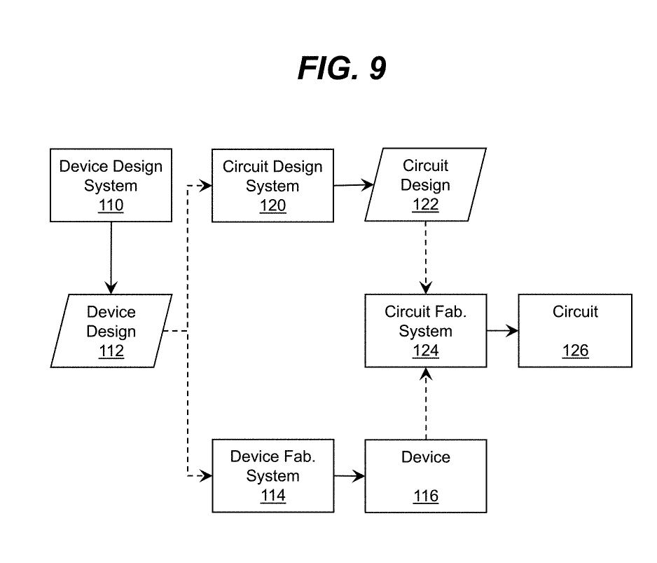

In one embodiment, the invention provides a method of designing and/or fabricating a circuit that includes one or more of the devices (e.g., optical modulators) designed and fabricated as described herein. To this extent, FIG. 9 shows an illustrative flow diagram for fabricating a circuit 126 according to an embodiment. Initially, a user can utilize a device design system 110 to generate a device design 112 for a semiconductor device as described herein. The device design 112 can comprise program code, which can be used by a device fabrication system 114 to generate a set of physical devices 116 according to the features defined by the device design 112. Similarly, the device design 112 can be provided to a circuit design system 120 (e.g., as an available component for use in circuits), which a user can utilize to generate a circuit design 122 (e.g., by connecting one or more inputs and outputs to various devices included in a circuit). The circuit design 122 can comprise program code that includes a device designed as described herein. In any event, the circuit design 122 and/or one or more physical devices 116 can be provided to a circuit fabrication system 124, which can generate a physical circuit 126 according to the circuit design 122. The physical circuit 126 can include one or more devices 116 designed as described herein.

In another embodiment, the invention provides a device design system 110 for designing and/or a device fabrication system 114 for fabricating a semiconductor device 116 as described herein. In this case, the system 110, 114 can comprise a general purpose computing device, which is programmed to implement a method of designing and/or fabricating the semiconductor device 116 as described herein. Similarly, an embodiment of the invention provides a circuit design system 120 for designing and/or a circuit fabrication system 124 for fabricating a circuit 126 that includes at least one device 116 designed and/or fabricated as described herein. In this case, the system 120, 124 can comprise a general purpose computing device, which is programmed to implement a method of designing and/or fabricating the circuit 126 including at least one semiconductor device 116 as described herein.

In still another embodiment, the invention provides a computer program fixed in at least one computer-readable medium, which when executed, enables a computer system to implement a method of designing and/or fabricating a semiconductor device as described herein. For example, the computer program can enable the device design system 110 to generate the device design 112 as described herein. To this extent, the computer-readable medium includes program code, which implements some or all of a process described herein when executed by the computer system. It is understood that the term “computer-readable medium” comprises one or more of any type of tangible medium of expression, now known or later developed, from which a stored copy of the program code can be perceived, reproduced, or otherwise communicated by a computing device.

In another embodiment, the invention provides a method of providing a copy of program code, which implements some or all of a process described herein when executed by a computer system. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a device design system 110 for designing and/or a device fabrication system 114 for fabricating a semiconductor device as described herein. In this case, a computer system can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. An optical modulator comprising:
a wave guide layer formed of an electro-optical material;
a first electrode directly contacting a first side of the wave guide layer;
a second electrode directly contacting the first side of the wave guide layer, wherein the first and second electrodes are located laterally adjacent to each other;
a first optical wave guide region, wherein the first optical wave guide region is located within the wave guide layer and is aligned with a first lateral location corresponding to a first electric field peak associated with the first electrode; and
a second optical wave guide region, wherein the second optical wave guide region is located within the wave guide layer and is aligned with a second lateral location corresponding to a second electric field peak associated with the second electrode.

2. The modulator of claim 1, wherein the wave guide is formed of lithium niobate.

3. The modulator of claim 1, further comprising a semiconductor channel located on the first side of the wave guide layer, wherein the first and second electrodes are located between the semiconductor channel and the wave guide layer.

4. The modulator of claim 3, further comprising a substrate directly contacting an opposite side of the semiconductor channel as the wave guide layer.

5. The modulator of claim 3, further comprising a semiconductor barrier located directly on the semiconductor channel, wherein the first and second electrodes are located on the semiconductor barrier.

6. The modulator of claim 3, further comprising a dielectric layer located on the semiconductor channel, wherein the first and second electrodes are located directly on the dielectric layer.

7. The modulator of claim 1, wherein the first optical wave guide region is aligned with an edge of the first electrode closest to the second electrode.

8. The modulator of claim 7, wherein the second optical wave guide region is aligned with an edge of the second electrode closest to the first electrode.

9. The modulator of claim 1, further comprising:
a source electrode located on the first side of the wave guide layer;
a drain electrode located on the first side of the wave guide layer, wherein the first and second electrodes are located laterally between the source electrode and the drain electrode.

10. The modulator of claim 9, wherein the first optical wave guide region is aligned with an edge of the first electrode closest to the drain electrode, and wherein the second optical wave guide region is aligned with an edge of the second electrode closest to the drain electrode.

11. The modulator of claim 1, wherein at least one of the first optical wave guide region or the second optical wave guide region, is formed by an impurity diffused into the wave guide layer.

12. The modulator of claim 1, wherein at least one of the first optical wave guide region or the second optical wave guide region, is formed by a profiled surface of the optical modulator.

13. A circuit comprising:
an optical modulator comprising:
a wave guide layer formed of an electro-optical material;
a first electrode directly contacting a first side of the wave guide layer;
a second electrode directly contacting the first side of the wave guide layer, wherein the first and second electrodes are located laterally adjacent to each other;
a first optical wave guide region, wherein the first optical wave guide region is located within the wave guide layer and is aligned with a first lateral location corresponding to a first electric field peak associated with the first electrode; and
a second optical wave guide region, wherein the second optical wave guide region is located within the wave guide layer and is aligned with a second lateral location corresponding to a second electric field peak associated with the second electrode; and
a set of control voltage sources, wherein the set of control voltage sources are configured to operate the optical modulator to selectively create one of: the first electric field peak or the second electric field peak.

14. The circuit of claim 13, wherein the set of control voltage sources includes a modulation voltage source for providing alternating positive and negative voltages to the first and second electrodes.

15. The circuit of claim 13, wherein the optical modulator further includes:
a source electrode located on the first side of the wave guide layer;
a drain electrode located on the first side of the wave guide layer, wherein the first and second electrodes are located laterally between the source electrode and the drain electrode, and
wherein the circuit further includes a drain voltage source for providing a direct current drain voltage to the drain electrode.

16. The circuit of claim 15, wherein the set of control voltage sources provides gate voltages to the first and second electrodes such that a gate voltage applied to one of the first and second electrodes results in an off channel below the one of the first and second electrodes and a gate voltage applied to the other of the first and second electrodes results in an on channel below the other of the first and second electrodes.

17. An optical modulator comprising:
a wave guide layer formed of an electro-optical material;
a source electrode located on a first side of the wave guide layer;
a first gate electrode located on the first side of the wave guide layer;
a second gate electrode located on the first side of the wave guide layer;
a drain electrode located on the first side of the wave guide layer, wherein the first and second gate electrodes are located laterally between the source electrode and the drain electrode;
a first optical wave guide region located within the wave guide layer, wherein the first optical wave guide region is aligned with an edge of the first gate electrode closest to the drain electrode; and
a second optical wave guide region located within the wave guide layer, wherein the second optical wave guide region is aligned with an edge of the second gate electrode closest to the drain electrode.

18. The modulator of claim 17, further comprising a semiconductor channel located on the first side of the wave guide layer, wherein each of the electrodes is located between the wave guide layer and the semiconductor channel.

19. The modulator of claim 18, further comprising a semiconductor barrier located between the wave guide layer and the semiconductor channel.

20. The modulator of claim 18, further comprising a dielectric layer located directly on the semiconductor channel, wherein the first gate electrode and the second gate electrode are located directly on the dielectric layer.
